(19) United States
(12) Patent Application Publication
(10) Pub. No.: US 2016/0302888 A1
(43) Pub. Date: Oct. 20, 2016

(54) ORTHODONTIC TOOL FOR THE PLACEMENT, POSITIONING AND ATTACHING OF BRACKETS ON THE VESTIBULAR SURFACE OF THE TOOTH

(71) Applicant: UNIVERSIDAD NACIONAL DE COLOMBIA, Bogotá (CO)

(72) Inventors: Gabriel GARCÍA ACOSTA, Bogota (CO); Karen LANGE MORALES, Bogota (CO); David Ernesto PUENTES LAGOS, Bogota (CO); Sara Estela PARADA PARADA, Bogota (CO); Manuel Ricardo RUIZ ORTIZ, Bogota (CO); Ana María GARZÓN PACHECO, Bogota (CO); William Ricardo LEÓN CASTELLANOS, Cundinamarca Soacha (CO); Juan Ricardo ÁLVAREZ, Cundinamarca Chia (CO); Carlos Julio VANEGAS MATA, Bogota (CO); Jhon Walther NUÑEZ VILORIA, Bogota (CO)

(73) Assignee: UNIVERSIDAD NACIONAL DE COLOMBIA, BOGOTÁ (CO)

(21) Appl. No.: 14/913,307

(22) PCT Filed: Aug. 15, 2014
(86) PCT No.: PCT/IB2014/063934

§ 371 Date: Jul. 7, 2016

(30) Foreign Application Priority Data
Aug. 20, 2013 (CO) 13-196767

(51) Int. Cl. A61C 7/14

(52) U.S. Cl. CPC A61C 7/146

(57) ABSTRACT

The invention relates to an orthodontic tool for the placement, positioning and attaching of brackets using a direct or indirect method, said tool comprising two parts: a body for manipulating the device (1) and a point (2). The shape of the body (1) is compatible with the hand and offers the user control and comfort when arranging the bracket (100) on the target—the target being the mesiodistal centre of the dental piece or tooth—at a predetermined height (202), resulting in precision and accuracy.

### TECHNICAL FIELD

The present invention relates to a device for the placement, positioning and bonding of brackets on the teeth using a direct or indirect method, ensuring a greater efficiency and effectiveness in dental positions in an orthodontic treatment, resulting in precision and accuracy. The expression tooth or dental piece will be indistinctly used herein.

### BACKGROUND

Different types of apparatus have been developed for the treatment of dento-maxillofacial anomalies, apparatus such as pre-adjusted brackets, which may be attached to the labial or lingual surface of the teeth.

The placement accuracy of these attachments is essential so that the features included therein can be fully and effectively expressed. This helps the mechanical treatment and improves the consistency of the results. Literature regarding the subject: Bennett, J. C & McLaughlin, R. P, 1998, Orthodontic Management of the Dentition with the preadjusted appliance. Andrews (1972; 1976; The six keys to normal occlusion. Am J Orthod; 296-309; El sistema diagnóstico; análisis oclusal; Clinicas odontológicas de Norte América. (Unpublished work), and then McLaughlin y Bennett (1989, 1995, 1998; 2002; The transition from standard edgewise to preadjusted Appliance systems, J Clin Orthod. 23; 142-153; Bracket placement with the preadjusted Appliance, J. Clin Orthod, 29:302-11; Orthodontic Management of the Dentition with the preadjusted appliance; Mecánica Sistematizada del Tratamiento ortodóncico), developed bracket-placement systems that have evolved over time. Said placement systems provide placement techniques or methods, brackets that work in conjunction with a dental-positioning method (tables, calculus and placement guides per tooth), and instruments or tools for the placement. All developments and evolution of the placement systems are seeking an optimization and enhancement of the quality of the orthodontic treatment.

However, the techniques or methods of placement have been evolving and adjusting, and even some methods and techniques for the positioning method supported in the CAD/CAM technologies have also advance: Ciuffolo, F., Epifania, E., Duranti, G., De Luca, V., Raviglia, D., Rezza, S., et al., 2006, Rapid prototyping: A new method of preparing trays for indirect bonding. American Journal 5 of Orthodontics and Dentofacial Orthopedics: Official Publication of the American Association of Orthodontists, its Constituent Societies, and the American Board of Orthodontics, 129(1), 75-77. Similarly, the types of brackets have been technologically refined and developed along with the dental-positioning method, according to the materials and the efficiency of their function. Nevertheless, the instruments and different types of orthodontic tools for positioning brackets have not been developed as an integrated whole; they only respond to a specific aspect of activity; they are partially and sequentially useful; they help to either visualize the angle with respect to the longest axis of the tooth, to measure the height at which to place the bracket, to locate the center of the tooth, or, at best, to connect two of the above-mentioned features.

The great flaw of the toolkit is that it must be used in a sequence; therefore, there were established some parameters at the time of positioning the brackets that can be used as reference, e.g. the orthodontist takes other measures and tends to verify the measures previously taken, which results in repetitions of steps affecting the reliability of the placement, extending the time of treatment sessions, and generally preventing an efficient and effective work.

For all foregoing reasons, the existing design of the placement instrument does not provide reliability to the orthodontist, so that a good treatment, as well as the precision and accuracy levels when placing each bracket, still depends, in a large percentage, on the skills and experience of the orthodontists.

There are two types of positioning brackets: the direct and indirect method. The direct method of positioning brackets broadly includes the following steps:

a) determining the longitudinal axis of the tooth;
b) measuring the proper height for each bracket;
c) guides on the dental crown;
d) placement of the bracket on the tooth;
e) verification of height;
f) reposition of the bracket;
g) new verification.

This positioning cycle is repeated for each tooth.

General parameters for a proper placement of a bracket has the center of the clinical crown of the tooth as the vertical reference (bearing in mind that the clinical crown has a longitudinal axis), and a horizontal axis defined according to a height from the pre-established incisal edge for each tooth according to some reference tables. In addition, and based on the vertical and horizontal axes, no production of a deviation angel is sought.

The indirect method refers to the technique in which the brackets are placed on study models and then transferred to the patient's mouth by using a tray. This technique dates back to 1972, in a publication of Silverman en el Am. J. Orthod: Silverman Et Al; A universal direct bonding System for both metal and plastic brackets. Am J Orthod 62; 236-244. Obtaining an alginate impression and study models is required, and vertical lines are drawn on each tooth. A panoramic dental x-ray can be used as a guide during the process. The bonding material is placed on the bracket's base so that it may be taken to each of the teeth in the model that has been prepared with an insulation medium. A transfer tray is built on this model for its placement inside the mouth before the preparation of the teeth with acid and the bonding material. When the brackets are placed in the model, the positioners are used to verify a proper height and position. The advantages of this technique over the direct method are the placement accuracy of the apparatus (since it is prepared at the laboratory prior its placement on the patient), a chair-time reduction and more comfort for the patient. The disadvantage is that it requires an extra process at the laboratory and that the procedure itself is a bit complex and requires high precision when the transfer tray is brought to the mouth.

In general, several problems may occur when placing a bracket, such as:
1) Mesiodistal position problems that deflect the bracket towards any of the sides of the tooth (mesial or distal) relative to the vertical axis, which leads to undesirable rotations.
2) Vertical position or deflection from the tooth height problems that produce extrusions or intrusions, as well as problems with the torque and the lingual-vestibule positions of the tooth.
3) Angular or parallel (to the axis) problems, that is, when the wings of the bracket are not parallel to the vertical axis and produces an undesired inclination of the tooth.
4) Thickness problems that are produced by an excessive use of bonding material beneath the bracket's base or by not achieving a successful adjustment of the base with the tooth, which may cause adverse rotations.

All the foregoing reinforces the idea of having tools that may help in obtaining an accurate and reliable placement of the bracket for finally achieving results in the position of the tooth according to the goals of the treatment.

Now, there are some technological proposals in the state of art, such as in the case of document U.S. Pat. No. 3,871,098, that suggest a positioning system comprising a predetermined height, however, its handling with one hand becomes more difficult, and the precision and accuracy are affected due to the way the device should be controlled and held. Document U.S. Pat. No. 4,850,864 discloses a bracket placing instrument for measuring the height and width of the tooth through three different types of arms, achieving a sophisticated and difficult-to-handle mechanism. It requires the use of magnets for holding and placing the bracket, and the use of a servo system that would optimize the position of the bracket in the desired location. Documents U.S. Pat. No. 7,214,056 and U.S. Pat. No. 6,682,344 disclose an orthodontic bracket placement device comprising a horizontal member for engaging the bracket that is adjusted by an adjustable vertical scale. Document U.S. Pat. No. 6,783,359 claims an instrument comprising two escualizable ends allowing the vertically millimeter-adjustable placement of the bracket with marginal ridges as reference rather than a single peak (it does not control the mesiodistal location or the long axis of the tooth).

Document U.S. Pat. No. 6,726,472 claims a gauge for marking different vestibular vertical heights either on the teeth or models. Similarly, document U.S. Pat. No. 5,312,248 discloses a device set to make a vertically visible mark on the surface of the tooth allowing to set different heights.

Document U.S. Pat. No. 7,125,249 teaches an instrument that not only allows the placing of the bracket but also provides a light source that emits radiation to cure the adhesive, but there is not any element in the design assisting an accurately placement of the bracket.

Document U.S. Pat. No. 6,682,344 is seeking a device ensuring the control of the height of the bracket, by a base on the incisal edge of the teeth that allows a different desired placement height of a bracket on a tooth, and also has an element that allows the perpendicularly placement of the tooth. The device also has another side for another additional function. It uses a bi-digital grip for placing the brackets, which can generate alterations in the precision and required accuracy for the treatment.

Documents U.S. Pat. No. 6,334,772, U.S. Pat. No. 6,695,313 and U.S. Pat. No. 6,976,840 disclose a guide system that displays an image on a screen allowing the orthodontist to check the vertical and horizontal condition of the brackets by using a tracking software that allows complementing the images captured with a camera comprising verification guidelines; however, these patents do not specify how the camera located parallel to the positioning device is handled, as the handling system and the electrical equipment connections can alter the control precision, and, therefore, the accuracy at the time of placing each bracket on the surface of the teeth.

As a result of the foregoing, the object of the present invention is to design an integrated tool improving the precision and accuracy in positioning the brackets in an orthodontic treatment, so that professionals in the field may achieve a greater effectiveness and reliability in developing their goals.

Regarding the placement procedure, this invention is intended to increase the accuracy and precision; to reduce working time; and to lower the cost of orthodontic treatments. With regard to the orthodontist, the following objectives were established: To contribute to a better body posture; to facilitate the handling of the tool; to increase the perception of quality in the positioning of the brackets; to avoid reverification and relocation of brackets; to reduce work time per patient; and to reduce the number of operations as much as possible.

### SUMMARY OF THE INVENTION

Based on the needs of orthodontists, a tool or instrument for positioning an orthodontic bracket on the vestibular surface was developed, tool that provides the necessary features for its operation, and comprises ergonomic features allowing a greater precise and accurate handling thereof.

According to the present invention, the orthodontic tool has a body whose structure facilitates a more anatomical compatibility therewith, i.e., a better coupling by the hand, which allows the orthodontist to have a better handling (1) and a point (2), which are firmly and jointly bonded together by any attachment mechanism known in the prior art. The point (2) has two functional components: a shovel-shaped bracket holder element (3) holding the bracket (100) with a 0.18″ or 0.22″ slot width (104) to be placed, and reference guides. These reference guides are divided into: a light projector (4) that emits a light beam (400) on the tooth (200) which allows the horizontally aligning of the bracket (100) with respect to the incisal edge of the tooth (201); a filament (5) that goes through the bracket holder (3) tangential to the vestibular surface of the tooth, which ensures the vertically placement of the bracket (100), and allows the expected expression of the components pre-established as torque and mesiodistal angulation; and an incisal guide (6) used to determine the height of the bracket contact (100) in the horizontal direction, and to ensure the parallelism of projected light beam (400); the bracket holder (3) is exchangeable to be adjusted to different dimensions of the bracket slot (102), according to the different heights and depths of the cases, configured on the front part as a support plate, which consists on a horizontal plate configured for fitting into the bracket slot (102), and it is part of the topology of the entire point. The second element is a light projector (4) whose basic configuration is a conical volume intersected by a triangular-shaped case having a horizontal slot, through which a high-intensity light beam (400) passes. The high-intensity light emitter is located inside the point, but subjected to the general body. The emitted light beam (400) is projected onto the tooth to be treated as a horizontal line (transverse axis), aligned with the slot (102) and laterally extended, to be used as a horizontal reference for the location of the bracket (100). The third element is the incisal guide (6) consisting of a “L-shaped” rigid structure, which is located among the general body and the point in order to predetermine the height or distance between the incisal edge (201) and the bracket slot center (102). The fourth element is a filament (5) going perpendicularly through the plate holding the bracket (3a), which is used as a reference to verify the position of the incisal guide (6) in the mesiodistal and sagittal direction of the tooth.

### DESCRIPTION OF THE DRAWINGS

FIG. 1 is an isometric view of the structure of a common orthodontic bracket.

FIG. 2 shows an isometric view of the orthodontic tool for positioning brackets. It also shows the shape and overall volume of the body as a handling component (1), and the point as a bracket placement component (2).

FIG. 3 is an exploded view of the entire orthodontic tool for positioning brackets, including bracket holder (3), light projector (4), perpendicular filament (5), incisal guide (6).

FIG. 4 is a section of the point of the orthodontic tool for positioning brackets, where the light source and its location is shown.

FIG. 5 is a side view of the positioner.

FIG. 6 is a front view of the positioner.

FIG. 7 is a bottom view of the positioner.

FIG. 8 is a detailed view of the point.

FIG. 9 shows how the bracket is positioned in accordance with embodiments of the present invention.

FIG. 10 is a side view of the somatography for the right hand, showing the coupling position of the hand and the handling of the positioner.

FIG. 11 is a front view of the somatography for the right hand, showing the coupling position of the hand and the handling of the positioner.

FIG. 12 is a perspective of the shape of the grip of the positioner, showing the type of grip and the handling form of the positioner.

FIG. 13 is a side view of the device handling body (1).

FIG. 14 is an isometric view of the bracket holder element (3).

FIG. 15 is an isometric view of the light projector (4).

FIG. 16 is an isometric view of the incisal guide (6).

FIG. 17 is a front view showing the alignment of the tooth, the bracket (100), the light beam (400), the filament (5), and the incisal guide (6).

FIG. 18 is a view of the body (casing) on the inside, where laminar partitions are shown.

FIG. 19 are front views of the tooth showing the light beam and filament assembly operating as parameters to avoid, on the mesiodistal plane, inclinations or deviations from the center of the crown.

### DETAILED DESCRIPTION OF THE INVENTION

In order to develop the tool herein claimed, it was necessary to know in detail the problems faced by the orthodontist in the practice, and thus provide a functional solution. There are two types of problems: operational and therapeutic.

The operational problems are related to the difficulty of the orthodontist to handle the tool with a comfortable and firm grip when placing the brackets on the teeth. The degree of precision is the criterion that allows to identify the tendency to consistently, repeatedly, and accurately target the same pre-established point. While it is true that the degree of precision is a criterion that depends in part on the skills and experience of the orthodontist, it is also true that both reference systems and positioning of the point, as well as the shape of the grip of the body, are variables affecting the degree of precision with which the brackets are placed on the labial surface of the tooth.

The therapeutic problems and their treatment are influenced, among other factors, by the correct location of the bracket. According to the above, the degree of accuracy is the criterion for recognizing whether the reference physical media of the orthodontic tool for positioning brackets herein claimed (reference systems and positioning of the point) allow to locate and then place the bracket on the pre-established labial surface of each tooth according to their shape, type and position.

Regarding operational problems faced by the orthodontist in the process of placing brackets, it was found that the most notorious difficulties are how to grab and hold the tool and how to handle the tool for placing each bracket. Therefore, and in order to solve these problems, the tool claimed herein provides a topology of the body (1) facilitating, on the one hand, the firm grip of the tool and, on the other hand, providing stability to the hand-tool assembly during use for improving the degree of precision of bracket placement.

The body (1) of the tool for positioning brackets comprises two hollow parts with thin walls that are mirror-symmetrical relative to the longitudinal plane, and each piece thus meets the property of chirality. The two hollow pieces attached on the longitudinal plane form a closed volume, which results on a housing appearance throughout the body (1) coupling the point (2), it is used to receive functional components and to create a firm grasp volume, and precise grip. When the hollow parts in the longitudinal plane are coupled, the front part forms a cylindrical connection area (la), with the necessary dimensions to receive and accurately couple the point (2) and the elements of the electrical circuit for the light beam emission. These pieces are joined together by any partial coupling method, so that the maintenance of said circuit and assembly is allowed.

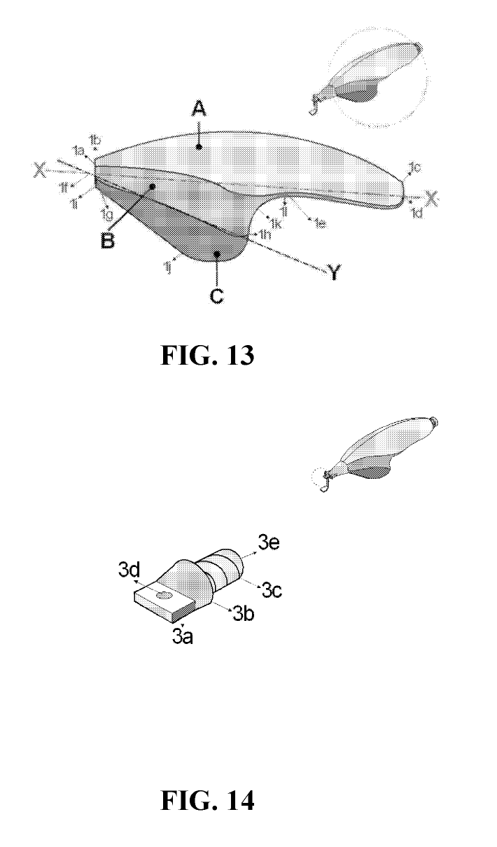

The form of one of the hollow parts (FIG. 18) is described below, bearing in mind that said topology is also used on the same terms for the other piece, under the principle of chiral symmetry. Since it comes into contact with the hand, the hollow part is rounded in its outer part and is made up of three differentiable surfaces (FIG. 13). Surface (A) towards the upper part of the body and with a convex topology; surface (B) at the central part of the body and with double-curved surfaces (with a concave topology at the front, and with a convex topology at the back); surface (B) is the area that comes into more contact with the hand when the tool is handled. Surface (C) at the lower part of the body with a convex topology.

There are series of laminar partitions (D) and coupling edges inside the hollow piece (FIG. 18) distributed so that they form a compartment network whose function, on the one hand, is to provide a structure to the hollow part, and, on the other hand, to be used as spaces for receiving parts and components of the electrical circuit sufficient and necessary for operation of the light source, which are known in the art.

Surface (A) is rounded and convex, and defined by a series of arc segments consecutively joint. The first arc is formed between points (1b) and (1e). Point (1b) is the leading edge of the first arc, and coincides with the base circle of the cone that forms the point (2). Point (1e) is the rear edge of the first arc and also the coupling point with the second semicircular arc, which ends at point (1d). Surface (A) has an ellipsoid shape, and results from the revolution of the two arcs formed and coupled between points (1b), (1e) and (1d) at about 90 degrees on the X axis. Surface (A) intersects surface (B) at the bottom forming a steak-shaped perimeter strip. Said steak is formed by the succession of an arc that creates a curve in revolution with a lying-‘S’-shaped path. A first arc between points (1d) and (1e) as an elongated and lying ‘s’, and a second arc with a greater distance, and with the same lying ‘s’ shape between points (1e) and (1f), are formed from the back of the body (1), but with their more pronounced ascender and descender surface evolution respective segments. The whole shape of surface (A) provides guidance of the grip when the tool is handled, and provides therefore an accurate placement of brackets, prevents injuries in the patient's mouth, and facilitates the cleaning of the device.

Surface (B) has a concave shape at the front forming a collar from the arc generated between points (1e) and (1f), and the succession of arcs formed between points (1g), (1h), (1k) and (1l). Surface (B) also adopts double curvature approximately between points (1k) and (1l). From point (1e) to the back (1d); surface (B) tends to close itself completing a backward-elongated ellipsoid.

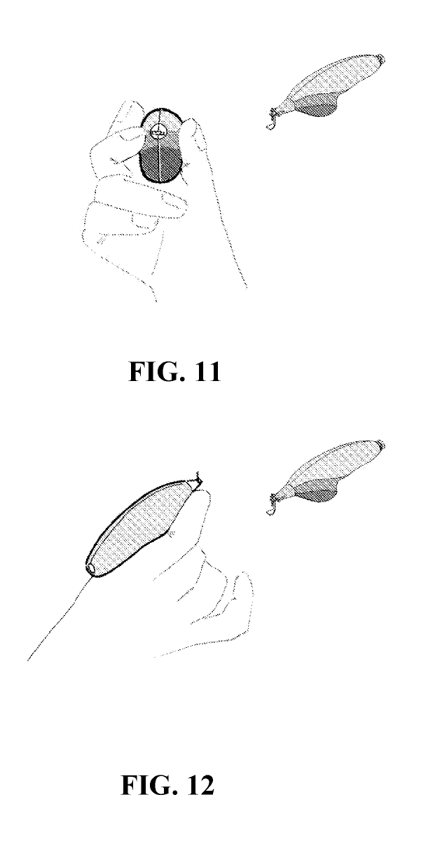

Functionally, when the hand comes into contact with the body, the back shape of surface (B), between points (1d) and (1k), rests on the dorsal side of the hand, within the back area of the index finger and the thumb finger (FIGS. 10, 11 and 12). The double curvature and the concave shape of the entire surface (B) are designed based on the biomechanical conditions of the hand during the grip and usability principles for establishing a better compatibility with the bi-digital or tri-digital-clamp-shaped grip adopted by the hand of the orthodontists during the handling of the tool claimed herein (FIGS. 10, 11 and 12). The optimal coupling between surface (B) and the hand produces a greater stability to the hand-tool assembly, and therefore contributes to the degree of precision of bracket placement.

Surface (C) is rounded and with a convex topology, and forms a perimeter edge that is used as a joint with surface (B). Said perimeter edge is an arc formed between points (1h) (at the back), and (1g) (at the front). The bottom perimeter of surface (C) is formed with two consecutive arcs, one substantially straight between points (1i) and (1h), and another with a semicircular shape between points (1j) and (1h). Surface (C) tends to be ovoid and is formed by two arcs formed and coupled between points (1i), (1j) and (1h) at about 90 degrees about the Y axis. Surface (C), due to its ovoid shape, is formally attached to the palmar side of the hand when the bi-digital or tri-digital grip is performed, and improves the force distribution and the center of gravity of the entire tool, which helps in the placement accuracy of the brackets.

In order to solve the therapeutic problems, it was considered that the tool claimed herein should provide a positioning system at the point (2), allowing to determine the mesiodistal line of the tooth and to accurately estimate the predetermined height from the incisal edge. Simultaneously, the tool must provide sufficient information on the angular deviation of the tooth-bracket assembly and the tangential contact degree between the surface of the bracket and the labial surface of the tooth where the bracket is placed.

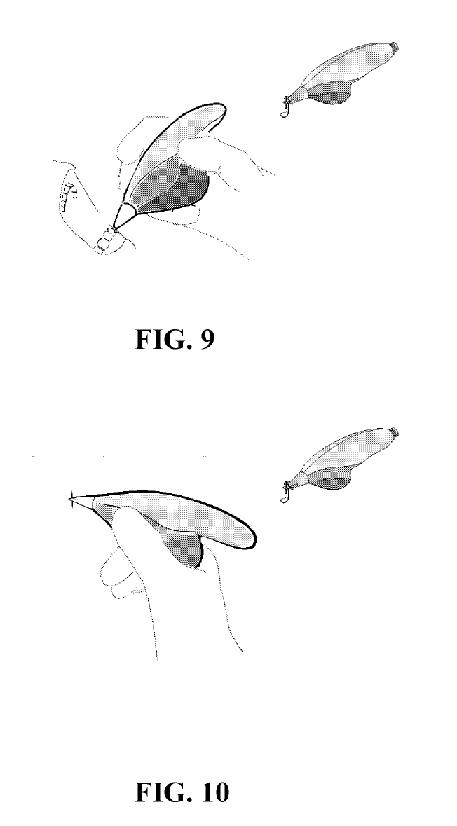

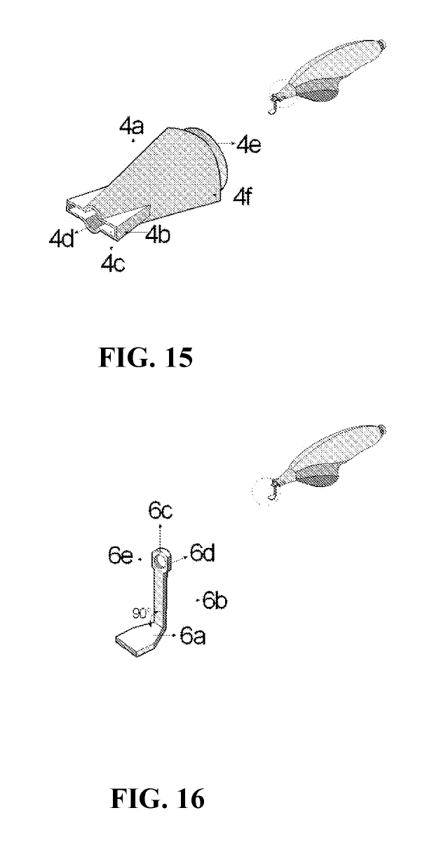

As shown in FIGS. 2, 3, 4, 9, 14, 15, 16 and 17, the point (2) of the tool has a number of functional components for positioning and bonding the brackets on the labial surface of the tooth, and, according to the embodiments claimed in the present invention, comprises a bracket holder element (3), a light projector (4), a filament (5) and an incisal guide (6).

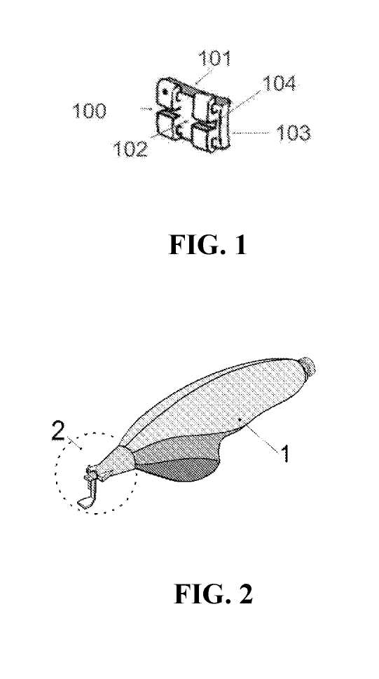

The holder bracket element (3) comprises three formally and functionally differentiated volumes (FIGS. 14, 1, 4, 3): a laminar support (3a) with a rectangular shape (plate) inserted and fitted into the bracket slot (102) with a 0.18″ or 0.22″ slot width (104), and used to hold the bracket (100) until it is positioned and bonded to the respective tooth (200); a truncated-cone-shaped intermediate volume (3b) that keeps the topology of the light projector (4); and a cylinder-shaped volume (3c) that is used for fitting and holding the incisal guide (6). Finally, said cylindrical segment (3c) of the bracket holder (3) is inserted and held in the front of the light projector (4). The cylindrical segment (3c) is threaded to ensure and allow the rotation of the incisal guide (6). Additionally, the laminar supports (3a) has a hole (3d) that goes through the main side perpendicular with the sufficient and necessary diameter to pass, receive and keep the filament (5); the position of said hole is calculated to not obstruct the area of the plate inserted and entered to the bottom of the bracket slot (102).

The light projector (4) is configured by the intersection of the following volumes (FIGS. 15, 4, 8): a hollowed truncated cone (4a) receiving a light source (4f) inside that stands out as a central volume; two hollowed trigonal prisms with the same rate and configuration (4b) are attached in an aligned manner on either side of the truncated cone point (4a) to set a continuous volume but hollow (4). A slot (4c) where a light beam (400) is emitted by the light source (40 is formed and horizontally projected as a line onto the labial surface of the tooth, due to the resulting configuration of the topological attachment of the cone and prisms.

This beamline (400) on either side of the tooth serves as a visual reinforcement for the correct position of the vertical height, as it is aligned with the bracket slot (102), and forms a reference line parallel to the occlusal plane/incisal edge. The beamline on either side of the tooth (400) also serves as a reference, alignment and mesiodistal angulation control of the bracket, as the same beamline strip rate must generally remain on either side of the tooth. The beamline (400) serves as reference and control of the pitch or rotation of the bracket relative to the occlusal plane/incisal edge. Finally, the truncated point (4d) which is part of the window serves to receive and house the bracket holder (3) and the incisal guide (6) as a functional assembly.

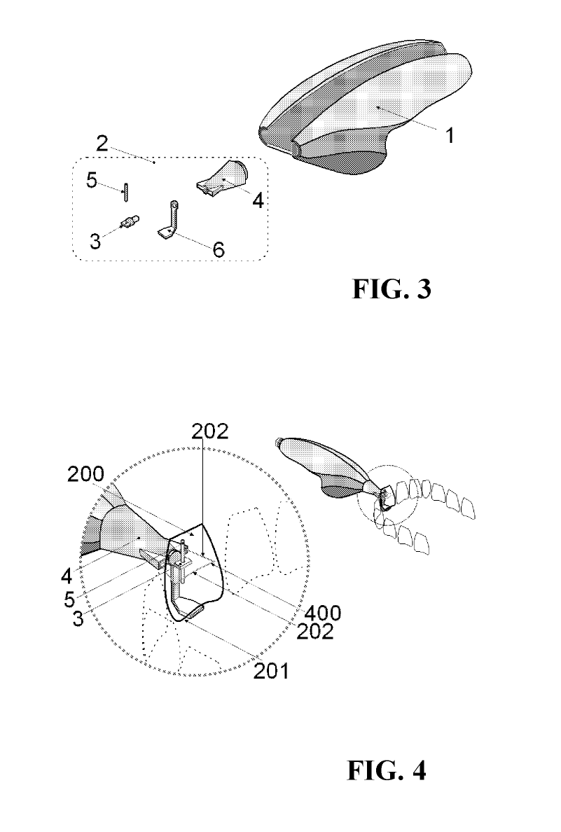

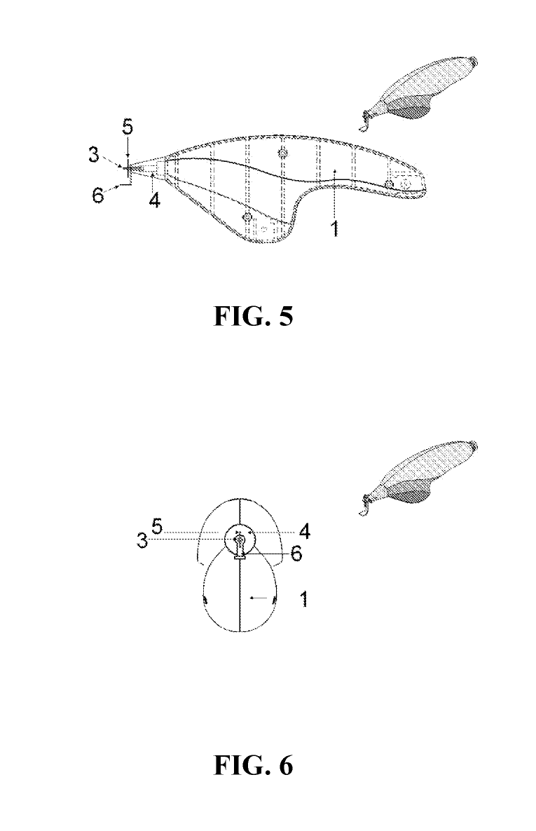

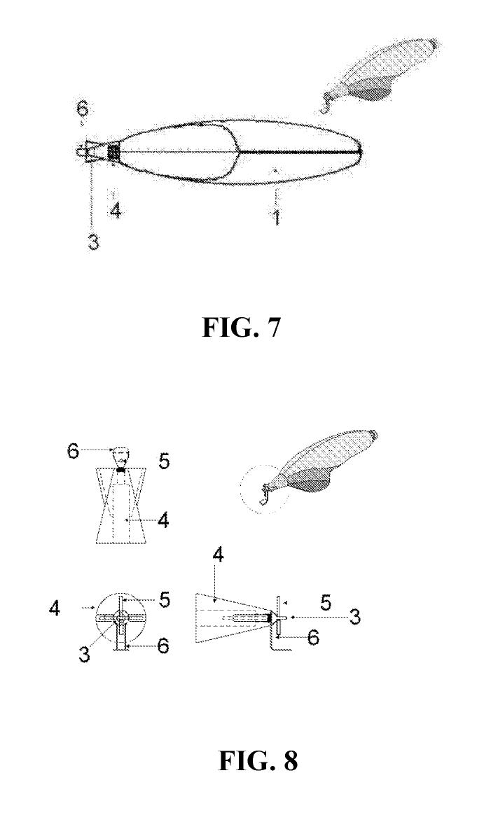

The filament (5) (FIGS. 3, 4, 8, 19) goes through the laminar support (3a) through the opening (3d) and has the required diameter to remain housed in said opening. The filament length is sufficient to be used as the position adjustment of the bracket with respect to the labial surface; the filament (5) works as a tangential witness regarding the labial surface of the tooth for helping in the vertical control of the incisal guide. The filament is of a rigid material so that it may be able to fulfill the function for which it was designed.

The incisal guide (6) is a plate (FIGS. 16, 3, 8, 17), which in its general configuration and laterally view has a ‘L’-shaped rigid form, with a 90 degree angle. This guide is interchangeable and serves for measuring the height from the incisal edge of the tooth (201) to a point of the clinical crown (202). There is an incisal guide (6) for each predetermined height, so that the orthodontist has a set of guides of different sizes available. Each guide has the size for the recommended centers and heights of each tooth according to treatment. The general body of each incisal guide (6) comprises three parts: the baseline (6a), which comes into contact with the tooth (200) and has a trapezoidal shape to ensure a proper contact with the incisal edge (201) of the different teeth; the post (6b), that due to its slim bar shape allows a visualization of the bracket holder assembly (3), filament (5) and bracket (100) forming 90 degrees along with the baseline (6a); and the head (6c), which gets connected with the bracket holder (3) and the light projector (4). The incisal guide (6) has an opening (6e) on the front side of the head (6c) whose center coincides with the axis of the bracket holder support (3e). At the same time, the axis of the bracket holder support (3e) coincides with the center of the labial surface of the clinical crown of the tooth (202) that will be placed the respective bracket (100). Finally, the incisal guide (6) has two sections (6d) parallel on either side of the head (6c) fulfilling two functions: firstly, to keep the guide still by forming a rigid assembly as a whole, that is, point (2); and on the other hand, the capability to change the position of the incisal guide (6) at about 180 degrees for positioning the bracket either in the maxilla or mandible.

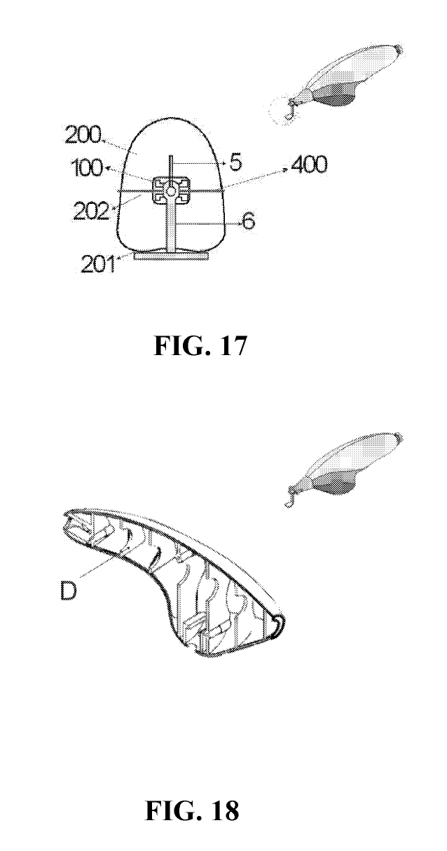

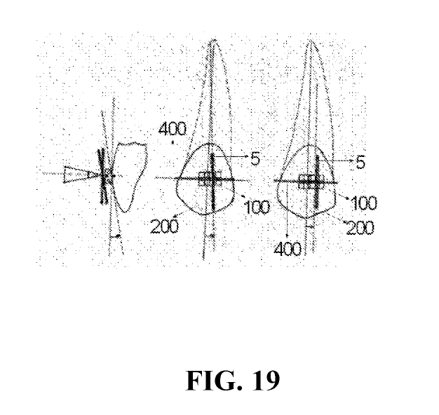

The components of the point (2) act as a whole, as a complement, and are redundant in that they are a set of references of location, position and placement of the bracket (100) in accordance with the requirements of orthodontic treatments. The beamline assembly (400) and filament (5) do not allow a displacement in the mesiodistal axis (FIGS. 17 and 19). The tool herein claimed is characterized in that it provides a more efficient and effective treatment, and reduces treatment times by optimizing a precise placement of brackets, as well as the biological cost of unsafe and constant replacement of brackets during treatment. The point tool and handling body can be manufactured in aseptic, sanitary or stainless materials, which are easy to sterilized and are known in the art.

1. Orthodontic tool for the placement, positioning and attaching of brackets on the vestibular surface of the tooth using the direct or indirect method, CHARACTERIZED IN THAT it consists of two parts: a body for the handling of the device (1) and a point (2); the shape of the body (1) allows the user to have control, safety, comfort and compatibility with the hand at the time of placing the bracket on the target, which is the mesiodistal center of the tooth at a predetermined height, and the point (2) consisting of: a (synergistically operating) bracket holder element (3), light projector (4), filament (5) and incisal guide (6) that ensure the horizontally and vertically placement of the bracket, and allow the setting of the components of the treatment, such as torque and mesiodistal angulation, to ensure an accurate and precise placement of brackets.

2. Orthodontic tool for the placement, positioning and attaching of brackets on the vestibular surface of the tooth using the direct or indirect method of claim 1, CHARACTERIZED IN THAT the handling body 1 comprises two hollow parts assembled by any attachment mechanism known in the prior art, parts that are manufactured with any sanitary or sterilizable aseptic material; there are a series of laminar and edge partitions (D) inside the parts forming compartments which are used to either grant structure to the piece, or to house the electrical circuit components, which are necessary for the operation of the light source.

3. Orthodontic tool for the placement, positioning and attaching of brackets on the vestibular surface of the tooth using the direct or indirect method of claim 1, CHARACTERIZED IN THAT the body (1) used for the handling of the device comprises two chiral symmetry hollow parts joined together to form a closed volume, each hollow part on the outside has rounded shapes that are configured by three differentiable surfaces allowing a firm grasp of the point and a comfortable work for accurately positioning the brackets when the body is coming into contact with the hand; surface (A) towards the upper part of the body and with a convex topology; surface (B) at the central part of the body and with double-curved surfaces, whose area comes into more contact with the hand when the tool is handled; and finally, surface (C) at the lower part of the body with a convex topology.

4. Orthodontic tool for the placement, positioning and attaching of brackets on the vestibular surface of the tooth using the direct or indirect method of claim 3, CHARACTERIZED IN THAT surface (A) is rounded and convex, and has an ellipsoid shape, and results from the revolution of the two arcs formed and coupled between points (1b), (1e) and (1d) at about 90 degrees on the X axis; surface (A) intersects surface (B) at the bottom forming a steak-shaped perimeter strip, said steak is formed by the succession of an arc that creates a curve in revolution with a lying-‘S’-shaped path; the whole shape of surface (A) provides guidance of the grip when the tool is handled, and prevents therefore injuries in the patient's mouth, and facilitates the cleaning of the device.

5. Orthodontic tool for the placement, positioning and attaching of brackets on the vestibular surface of the tooth using the direct or indirect method of claim 3, CHARACTERIZED IN THAT surface (B) has a concave shape at the front forming a collar from the arc generated between points (1e) and (1f), and the succession of arcs formed between points (1g), (1h), (1k) and (1l), then adopts a double curvature between points (1k) and (1l); when the hand comes into contact with the body, the back shape of surface (B), between points (1d) and (1k), rests on the dorsal side of the hand, within the back area of the index finger and the thumb finger, the double curvature and its concave shape are derived from biomechanic principles of the hand during the gripping and is based on usability criteria. The topology of surface (B) generates anatomical compatibility with the bi-digital or tri-digital-clamp-shaped grip adopted by the hand during the handling of the tool.

6. Orthodontic tool for the placement, positioning and attaching of brackets on the vestibular surface of the tooth using the direct or indirect method of claim 3, CHARACTERIZED IN THAT surface (C) has a convex topology that forms a perimeter edge that is used as joint with surface (B), said perimeter edge is an arc formed between points (1h) (at the back), and (1g) (at the front); surface (C) tends to be ovoid and is formed by two arcs formed and coupled between points (1i), (1j) and (1h) at about 90 degrees about the Y axis; surface (C), due to its ovoid shape, is formally attached to the palmar side of the hand when the bi-digital or tri-digital grip is performed, and improves the force distribution and the center of gravity of the entire tool.

7. The orthodontic tool for the placement, positioning and attaching of brackets of claim 1, CHARACTERIZED IN THAT the functional components in the point (2) are interchangeable, and can be manufactured in aseptic, sanitary or stainless materials, such as: A shovel-shaped bracket holder element (3) holding the bracket to be placed and reference guides; theses reference guides are divided into: a light projector (4) that emits a light beam on the tooth which allows the horizontally aligning of the bracket with respect to the incisal edge of the tooth; a filament (5) that goes through the bracket holder (3), which is aligned according to mesiodistal distance of the bracket and tooth and tangential to the vestibular surface of the tooth, which ensures the vertically placement of the bracket, and allows the expected expression of the components pre-established as torque and mesiodistal angulation; and an incisal guide (6) used to determine the height of the bracket, and, in the horizontal direction, to ensure the parallelism of projected light beam, which works as a synergistic whole, providing information for the placement of the bracket to the predetermined height in a vertical mesiodistal, buccolingual and mesiodistal angulation direction for obtaining an accurate placement of the bracket.

8. The orthodontic tool for the placement, positioning and attaching of brackets of claim 7, CHARACTERIZED IN THAT at the point (2) the bracket holder (3) comprises three volumes: a laminar support (3a) with a rectangular shape inserted and fitted into the bracket slot, and used to hold the bracket until it is positioned and bonded to the tooth; a truncated cone (3b) that keeps the topology of the light projector (4); and a threaded cylinder (3c) engaged into the front of the light projector (4) and with the capability of changing its position to about 180 degrees, and hold the incisal guide (6) to locate brackets either upper or lower teeth; additionally, the laminar support (3a) has an opening (3d) that goes perpendicularly through the main side with the required diameter in order to pass and hold the filament (5).

9. The orthodontic tool for the placement, positioning and attaching of brackets of claim 7, CHARACTERIZED IN THAT at the point (2) the light projector (4), whose main volume is a hollow truncated cone (4a), houses a light source (40, two hollowed trigonal prisms with the same rate and configuration (4b) attached in an aligned manner on either side of the truncated cone point (4a) to set a continuous and hollow volume; a slot (4c) where a light beam (400) is emitted by the light source (40 is formed and horizontally projected as a metric line onto the labial surface of the tooth, due to the resulting configuration of the topological attachment of the cone and prisms. The light beam (400) is used: as a visual reinforcement for the correct position of the vertical height, as it is aligned with the bracket slot, and forms a reference line parallel to the occlusal plane/incisal edge; as an alignment and mesiodistal angulation control of the bracket; and, as reference and control of the pitch or rotation of the bracket relative to the occlusal plane/incisal edge; the truncated point (4d) serves to house the bracket holder (3) and the incisal guide (6) as a functional assembly.

10. The orthodontic tool for the placement, positioning and attaching of brackets of claim 7, CHARACTERIZED IN THAT at the point (2) the filament (5) goes through the laminar support (3a) through the opening (3d) and has the required diameter to remain housed in said opening, the filament length is sufficient to be used as the position adjustment of the bracket with respect to the labial surface; the filament (5) works as a tangential witness regarding the labial surface of the tooth for helping in the vertical control of the incisal guide. The filament is of a rigid material so that it may be able to fulfill the function for which it was designed.

11. The orthodontic tool for the placement, positioning and attaching of brackets of claim 7, CHARACTERIZED IN THAT at the point (2) the incisal guide (6), laterally view, has a ‘L’-shaped rigid form, with a 90 degree angle. This guide is interchangeable and serves for measuring the height from the incisal edge of the tooth to the previously defined height on the vertical axis of the tooth in its vestibular side; there is an incisal guide (6) for each predetermined height, so that there are a set of guides of different sizes according to the recommended heights in each tooth according to the treatment; the body of each incisal guide (6) comprises three parts: the baseline (6a), which comes into contact with the tooth and has a trapezoidal shape to ensure a proper contact with the incisal edge of the teeth; the bar-shaped post (6b) that allows a visualization of the bracket holder (3), the filament (5) and the bracket; and the head (6c), which gets connected with the bracket holder (3) and the light projector (4); the incisal guide (6) has an opening (6e) on the front side of the head (6c), whose center coincides with the axis of the bracket holder support (3e), and, at the same time, the axis of the bracket holder support (3e) coincides with the center of the vestibular side of the tooth. Finally, the incisal guide (6) has two sections (6d) parallel on either side of the head (6c) that keep the guide still by forming a rigid assembly at the point (2), and have the capability to change the position of the incisal guide (6) at about 180 degrees for positioning the bracket either in the maxilla or mandible.

12. Orthodontic tool for the placement, positioning and attaching of brackets on the vestibular surface of the tooth using the direct or indirect method of claim 2, CHARACTERIZED IN THAT the body (1) used for the handling of the device comprises two chiral symmetry hollow parts joined together to form a closed volume, each hollow part on the outside has rounded shapes that are configured by three differentiable surfaces allowing a firm grasp of the point and a comfortable work for accurately positioning the brackets when the body is coming into contact with the hand; surface (A) towards the upper part of the body and with a convex topology; surface (B) at the central part of the body and with double-curved surfaces, whose area comes into more contact with the hand when the tool is handled; and finally, surface (C) at the lower part of the body with a convex topology.
